(19) United States
(12) Patent Application Publication
(10) Pub. No.: US 2014/0044385 A1
(43) Pub. Date: Feb. 13, 2014

(54) CORROSIONS REDUCING FLEXIBLE PLAIN BEARING MATERIAL AND METHOD OF FORMING THE SAME

(71) Applicant: Zivko ANDELKOVSKI, Grevenbroich (DE)

(72) Inventor: Zivko ANDELKOVSKI, Grevenbroich (DE)

(21) Appl. No.: 13/941,188

(22) Filed: Jul. 12, 2013

Related U.S. Application Data
(60) Provisional application No. 61/671,674, filed on Jul. 13, 2012.

(51) Int. Cl. F16C 33/20

(52) U.S. Cl. CPC F16C 33/205; F16C 33/208
USPC 384/276; 156/60

(57) ABSTRACT

A method of reducing corrosion of a corrosive metal containing work piece includes providing a corrosive metal containing work piece having a non-planar surface. The method can further include covering at least about 10% of the non-planar surface with a laminate. The laminate can include an aluminum alloy mesh having a first major surface and a second major surface. The laminate can further include a sliding layer overlying the first major surface. The sliding layer can be in direct contact with the aluminum alloy mesh. In another aspect, a corrosion protection article can include a bushing. The bushing can be in a non-planar shape. The bushing can further be shaped to enfold a work piece. The bushing can include an aluminum alloy mesh having a first major surface and include a sliding layer overlying the first major surface. The sliding layer can be in direct contact with the aluminum alloy mesh.

### CROSS-REFERENCE TO RELATED APPLICATION(S)

This application claims priority under 35 U.S.C. §119(e) to U.S. Patent Application No. 61/671,674 entitled “CORROSIONS REDUCING FLEXIBLE PLAIN BEARING MATERIAL AND METHOD OF FORMING THE SAME,” by Zivko Andelkovski, filed Jul. 13, 2012, which is assigned to the current assignee hereof and incorporated herein by reference in its entirety.

### FIELD OF THE DISCLOSURE

The disclosure relates to slide bearings comprising an aluminum alloy mesh and a sliding layer applied to the aluminum alloy, wherein the slide bearing reduces corrosion of underlying metal parts.

### BACKGROUND

In the metal consuming industries, such as automotive industries, there are five existing types of steel corrosions, namely (i) uniform corrosion, (ii) crevice corrosion, (iii) pitting corrosion, (iv) cosmetic corrosion, and (v) galvanic corrosion. Galvanic corrosion also referred to as two-metal or bimetallic corrosion occurs when dissimilar metals or metal alloys are in contact in the presence of an electrolyte and or moisture. The more active, also called “anodic” metal or alloy corrodes while the more noble, also called “cathodic” metal or alloy remains undamaged. For example, on the galvanic scale copper or copper containing alloys, such as bronze, are less active than steel. Accordingly, if bronze-containing fabrics or parts are applied in the steel housing of a machine or automotive part, galvanic corrosion will damage the steel housing.

As such, materials to inhibit galvanic corrosion of the steel housing are needed.

### SUMMARY OF THE INVENTION

In a first aspect, a method of reducing corrosion of a corrosive metal containing work piece includes providing a corrosive metal containing work piece. The corrosive metal containing work piece can have a non-planar surface. The method can further include covering at least about 10% of the non-planar surface with a laminate. The laminate can include an aluminum alloy mesh having a first major surface and a second major surface. The laminate can further include a sliding layer overlying the first major surface. The sliding layer can be in direct contact with the aluminum alloy mesh. The second major surface of the aluminum alloy mesh can be in direct contact with the at least 50% of the non-planar surface.

In another aspect, a corrosion protection article can include a bushing. The bushing can be in a non-planar shape. The bushing can further be shaped to enfold a work piece. The work piece can have a non-planar surface. The bushing can include an aluminum alloy mesh having a first major surface and a second major surface. The bushing can further include a sliding layer overlying the first major surface. The sliding layer can be in direct contact with the aluminum alloy mesh.

In one further aspect, an article can include a first body. A portion of the first body can moveably engage a second body. The first body can have a contoured external surface. The first body can further have a contoured internal surface. The first body can include an aluminum alloy mesh. The first body can include a sliding layer. The sliding layer can overlie the aluminum alloy mesh. The sliding layer can include the external surface. The aluminum alloy mesh can include the internal surface of the first body.

In yet another aspect, a method of reducing corrosion at an interface of two ferrous body parts includes providing a first ferrous body part. The first ferrous body part can include a contoured shape. The contoured shape can include a first major surface area. The first ferrous body can be shaped to engage a second ferrous body. The method can further include overlying the first major surface area with the second ferrous body. A second surface of the second ferrous body can contact the first major surface area. The first major surface and the second major surface can include corrosive metal containing material. The first ferrous body part can include a corrosive metal containing carrier. The first ferrous body part can further include an aluminum alloy mesh. The aluminum alloy mesh can overlie the corrosive metal containing carrier material. The first ferrous body part can further include a sliding layer. The sliding layer can overlie the aluminum alloy mesh.

In a further aspect, a corrosion guard can include a bushing. The bushing can include a corrosive metal containing carrier. The corrosive metal containing carrier can be adapted to overly a ferrous work piece. The bushing can further include an aluminum alloy mesh having a first major surface and a second major surface. The first major surface of the aluminum alloy mesh can overlie the corrosive metal containing carrier. The bushing can further include a sliding layer. The sliding layer can overlie the second major surface of the aluminum alloy mesh.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary laminate.

FIG. 2 includes an illustration of another exemplary plain bearing.

FIG. 3 includes an illustration of automobile door hinge assembly.

FIG. 4 includes an illustration of an cross-sectional view of an automobile door hinge.

FIG. 5 includes an illustration of another automobile door hinge assembly.

FIGS. 6A and 6B include line diagrams of cross-sectional SEM pictures of plain bearings

The use of the same reference symbols in different drawings indicates similar or identical items.

### DESCRIPTION OF THE PREFERRED EMBODIMENTS

In the metal working industry, work pieces of different metallic compositions are combined. Such combination can be the cause of galvanic corrosion, especially where work pieces are moveably engaged. For example, door hinges in the automobile industry are composed of parts that are in long-lasting frictional use and concurrently exposed to the elements of nature. Often, mores stable metals or alloys, such as copper or bronze, are employed in some parts in the door hinges, for examples, in rivets, linings, ferrules. These elements are the cause of galvanic corrosion near or at the moveable part thereby reducing the lifetime of the door hinge.

Aluminum is a more active metal than steel. Accordingly in the presence of an electrolyte and/or moisture, an aluminum part in contact with the steel would corrode. Moreover, aluminum forms a dense aluminum oxide layer which is essentially inert and prevents further corrosion. If the aluminum oxide layer is impacted by mechanical use, such as friction thereby exposing aluminum metal, the metal continues to serve as an anodic metal, thereby maintaining the surrounding steel in a cathodic or corrosion-protected mode.

The tensile strength of aluminum, however, is too poor to make aluminum a stress bearing element such as a component in an automobile door hinge. Accordingly, aluminum alloys that provide an ideal mechanical property profile are better suited for such mechanical demand. Such alloys may also function as corrosion reducing components as long as the alloy itself remains anodic or more active than the surrounding steel housing.

In a first embodiment, a method of reducing corrosion of a corrosive metal containing work piece includes providing a corrosive metal containing work piece. The corrosive metal containing work piece can have a non-planar surface. The method can further include covering at least about 50% of the non-planar surface with a laminate. The laminate can include an aluminum alloy mesh having a first major surface and a second major surface. The laminate can further include a sliding layer overlying the first major surface. The sliding layer can be in direct contact with the aluminum alloy mesh. The second major surface of the aluminum alloy mesh can be in direct contact with the at least 50% of the non-planar surface.

The corrosive metal containing work piece includes corrosive metals and alloys comprising corrosive metals. The corrosive metal can include iron, aluminum, lithium, sodium, potassium, magnesium, calcium, strontium, barium, titanium, vanadium, chromium, manganese, cobalt, zinc, cadmium, gallium, indium, germanium, tin, lead, and any combination thereof. In one embodiment, the corrosive metal containing work piece comprises an iron containing work piece. In one further embodiment, the corrosive metal containing work piece consists of an iron containing work piece.

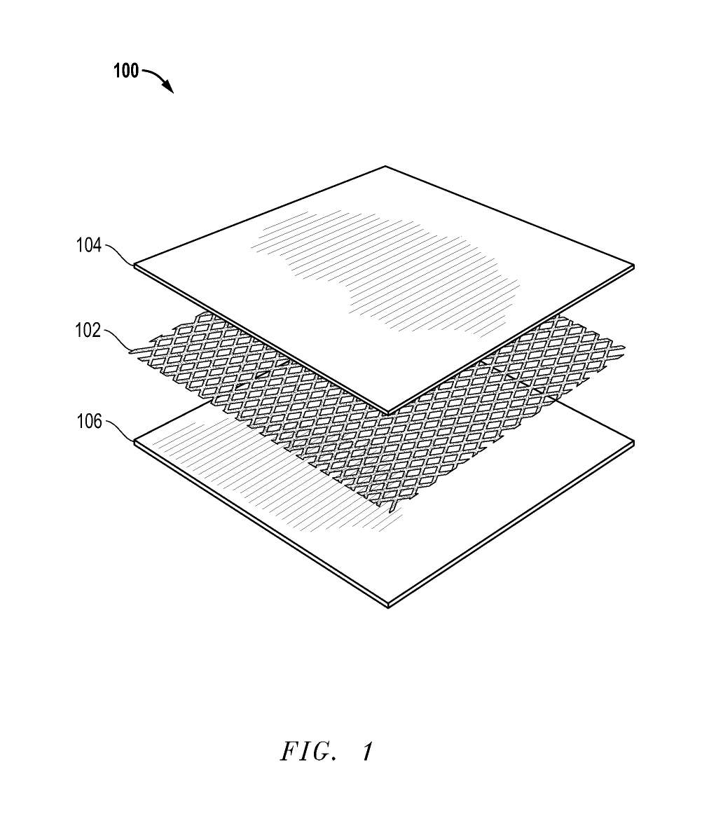

FIG. 1 depicts an exemplary laminate 100, comprising an aluminum alloy mesh 102, and a sliding layer 104. In some embodiments, the laminate can optionally include a carrier 106. In one embodiment, the carrier can be a corrosive metal containing carrier, such as a steel carrier,

In another embodiment, the covering can include at least about 20%, such as at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98% of the non-planar surface. In yet one further embodiment, the covering is not greater than about 99.9%, such as not greater than about 90%, not greater than about 60%, or not greater than about 40% of the non-planar surface.

In another embodiment, a corrosion protection article can include a bushing. The bushing can be in a non-planar shape. The bushing can further be shaped to enfold a work piece. The work piece can have a non-planar surface. The bushing can include an aluminum alloy mesh 102 having a first major surface and a second major surface. The bushing can further include a sliding layer overlying the first major surface. The sliding layer can be in direct contact with the aluminum alloy mesh 102.

In another embodiment, the bushing can be shaped complementary to the work piece. In yet another embodiment, the bushing can be engaged with the work piece and the second major surface of the aluminum alloy mesh 102 is in direct contact with the non-planar surface of the work piece. The work piece can be a corrosive metal containing work piece. In another embodiment, the work piece includes steel.

In one further embodiment, an article can include a first body. A portion of the first body can moveably engage a second body. The first body can have a contoured external surface. The first body can further have a contoured internal surface. The first body can include an aluminum alloy mesh 102. The first body can include a sliding layer 104. The sliding layer 104 can overlie the aluminum alloy mesh 102. The sliding layer 104 can include the external surface. The aluminum alloy mesh 102 can include the internal surface of the first body.

In yet another embodiment, a method of reducing corrosion at an interface of two ferrous body parts includes providing a first ferrous body part. The first ferrous body part can include a contoured shape. The contoured shape can include a first major surface area. The first ferrous body can be shaped to engage a second ferrous body. The method can further include overlying the first major surface area with the second ferrous body. A second surface of the second ferrous body can contact the first major surface area. The first major surface and the second major surface can include corrosive metal containing material. The first ferrous body part can include a corrosive metal containing carrier. The first ferrous body part can further include an aluminum alloy mesh 102. The aluminum alloy mesh 102 can overlie the corrosive metal containing carrier material 106. The first ferrous body part can further include a sliding layer 104. The sliding layer 104 can overlie the aluminum alloy mesh 102. In embodiments, the first ferrous body, the second ferrous body, the corrosive metal containing material, or corrosive metal containing carrier can include steel.

In one further embodiment, a corrosion guard can include a bushing. The bushing can include a corrosive metal containing carrier 106. The corrosive metal containing carrier can be adapted to overly a ferrous work piece. The bushing can further include an aluminum alloy mesh 102 having a first major surface and a second major surface. The first major surface of the aluminum alloy mesh 102 can overlie the corrosive metal containing carrier 106. The bushing can further include a sliding layer 104. The sliding layer 104 can overlie the second major surface of the aluminum alloy mesh 102.

In one embodiment, the corrosion guard can include an adhesive layer (not shown in FIG. 1) between the aluminum alloy mesh 102 and the corrosive metal containing carrier 106. In another embodiment, the corrosion guard can include an adhesive layer between the aluminum alloy mesh 102 and the sliding layer 104 carrier. In yet another embodiment, the aluminum alloy mesh 102 can be embedded in an adhesive layer. The adhesive layer can include a thermosetting adhesive such as an epoxy, a polyurethane, a cyanoacrylate, a acrylic polymers, or a combination thereof. The adhesive layer can also include a melt adhesive or thermoplastic. For example, the adhesive layer can include Ethylene-Vinyl Acetate (EVA), Ethylene vinyl alcohol (EVOH), Fluoroplastics (PTFE, alongside with FEP, PFA, CTFE, ECTFE, ETFE), Ionomers, acrylic/PVC alloy, Liquid Crystal Polymer (LCP), Polyoxymethylene (POM), Polyacrylates (Acrylic), Polyacrylonitrile (PAN), Polyamide (PA), Polyamide-imide (PAI), Polyaryletherketone (PAEK), Polybutadiene (PBD), Polybutylene (PB), Polybutylene terephthalate (PBT), Polycaprolactone (PCL), Polychlorotrifluoroethylene (PCTFE), Polyethylene terephthalate (PET), Polycyclohexylene dimethylene terephthalate (PCT), Polycarbonate (PC), Polyhydroxyalkanoates (PHAs), Polyketone (PK), Polyester, Polyethylene (PE), Polyetheretherketone (PEEK), Polyetherketoneketone (PEKK), Polyetherimide (PEI), Polyethersulfone (PES), Chlorinated Polyethylene (CPE), Polyimide (PI), Polylactic acid (PLA), Polymethylpentene (PMP), Polyphenylene oxide (PPO), Polyphenylene sulfide (PPS), Polyphthalamide (PPA), Polypropylene (PP), Polystyrene (PS), Polysulfone (PSU), Polytrimethylene terephthalate (PTT), Polyurethane (PU), Polyvinyl acetate (PVA), Polyvinyl chloride (PVC), Polyvinylidene chloride (PVDC), Styrene-acrylonitrile (SAN), and any combination thereof.

In one embodiment, the aluminum alloy mesh 102 can include an alloy of aluminum with the group consisting of magnesium, calcium, strontium, barium, scandium, titanium, vanadium, manganese, corrosive metal, cobalt, nickel, copper, zinc, gallium, indium, thalium, germanium, tin, lead, and any combination thereof. In one particular embodiment, the aluminum alloy mesh 102 includes an aluminum magnesium alloy. In yet another embodiment, the aluminum alloy mesh 102 consist essentially of an aluminum magnesium alloy. In one embodiment, the aluminum magnesium alloy includes at least about 3 wt % magnesium, such as at least about 3.5 wt % magnesium, at least about 3.7 wt % magnesium, at least about 3.9 wt % magnesium, at least about 4.0 wt % magnesium, at least about 4.1 wt % magnesium, at least about 4.2 wt % magnesium, at least about 4.3 wt % magnesium, at least about 4.4 wt % magnesium, at least about 4.5 wt % magnesium, at least about 4.6 wt % magnesium, at least about 4.7 wt % magnesium, at least about 4.8 wt % magnesium, at least about 4.9 wt % magnesium, at least about 5.0 wt % magnesium, at least about 5.5 wt % magnesium, at least about 6.0 wt % magnesium, or at least about 6.5 wt % magnesium. In another embodiment, the aluminum magnesium alloy includes not greater than about 10 wt % magnesium, such as not greater than about 9 wt %, not greater than about 8 wt %, not greater than about 7 wt %, or not greater than about 6 wt %.

In another embodiment, the aluminum magnesium alloy includes at least about 85 wt % aluminum, such as at least about 87 wt % aluminum, at least about 89 wt % aluminum, at least about 90 wt % aluminum, at least about 91 wt % aluminum, at least about 92 wt % aluminum, at least about 93 wt % aluminum, at least about 93.5 wt % aluminum, at least about 94 wt % aluminum, at least about 94.5 wt % aluminum, at least about 95 wt % aluminum, or at least about 95.5 wt % aluminum. In another embodiment, the aluminum magnesium alloy includes not greater than about 96 wt % aluminum, such as not greater than about 95 wt % aluminum, not greater than about 94 wt % aluminum, not greater than about 92 wt % aluminum, not greater than about 90 wt % aluminum, not greater than about 88 wt % aluminum.

In yet another embodiment, the alloys can have the stoichiometric description AlMgᵢᵢ, wherein n=0.5, 1, 2, 3, 4, 5, 6, or 7. In one particular embodiment, the alloy can be AlMg₅.

In one embodiment, the alloy mesh 102 comprises a woven mesh having a warp wire and a weft wire. In one embodiment, the warp wire and the weft wire can have the same thickness. In another embodiment, the warp wire has a thickness d₁ and the weft wire has a thickness d₂ and the ratio of d₂/d₁ can be at least about 1.5, such as at least about 2, at least about 2.5, or even at least about 3.0. In another embodiment, the ratio is not greater than about 8.0, or not greater than about 5.0. In another embodiment, the alloy mesh can be formed in the pattern of a diamond wire screen. The wires can be have a square, rectangular, or circular cross-section.

In one embodiment, the aluminum alloy mesh 102 has a mesh size of at least 10 mesh/inch, such as at least 11 mesh/inch, at least 13 mesh/inch, at least 15 mesh/inch, at least 17 mesh inch, at least 19 mesh/inch, or at least 21 mesh/inch. In another embodiment, the mesh size is not greater than 30 mesh/inch, such as not greater than 28 mesh/inch, not greater than 26 mesh/inch, not greater than 22 mesh/inch, not greater than 18 mesh/inch, or not greater than 16 mesh/inch.

In yet another embodiment, the aluminum alloy mesh 102 has a thickness of at least about 0.1 mm, such as at least about 0.2 mm, at least about 0.3 mm, at least about 0.4 mm, at least about 0.5 mm, or at least about 0.6 mm. In another embodiment the aluminum alloy mesh 102 has a thickness of not greater than about 0.8 mm, such as not greater than about 0.6 mm, not greater than about 0.5 mm, or not greater than about 0.4 mm.

With respect to the sliding layer 104, in embodiments, the sliding layer 104 can include a fluoropolymer. In another embodiment, the sliding layer 104 consists essentially of a fluoropolymer. The fluoropolymer can be selected from the group consisting of polychlorotrifluoroethylene (PCTFE), polytetrafluoroethylene (PTFE), tetrafluoroethylene-perfluoro(alkyl vinyl ether) copolymer (PFA), tetrafluoroethylene-hexafluoropropylene copolymer (FEP), tetrafluoroethylene-ethylene copolymer (ETFE), polyvinylidene fluoride (PVDF) and polyvinyl fluoride (PVF), a combination thereof, and a laminated film comprising two or more thereof.

In embodiments, the sliding layer 104 can have a thickness of at least about 0.05 mm, such as at least about 0.1 mm, at least about 0.15 mm, at least about 0.2 mm, at least about 0.25 mm, at least about 0.3 mm, at least about 0.35 mm, at least about 0.4 mm, or at least about 0.45 mm.

In other embodiment, the sliding layer 104 has a thickness of not greater than about 5 mm, such as not greater than about 4.5 mm, not greater than about 4 mm, not greater than about 3.5 mm, not greater than about 3 mm, not greater than about 2.5 mm, not greater than about 2 mm, not greater than about 1.5 mm, not greater than about 1 mm, not greater than about 0.5 mm.

In yet one further embodiment, the sliding layer 104 can further include a filler. The filler can be selected from fibers, glass fibers, carbon fibers, aramids, inorganic materials, ceramic materials, carbon, glass, graphite, aluminum oxide, molybdenum sulfide, bronze, silicon carbide, woven fabrics, powders, spheres, thermoplastic materials, polyimide (PI), polyamidimide (PAI), polyphenylene sulfide (PPS), polyphenylene sulfone (PPSO2), liquid crystal polymers (LCP), polyether ether ketones (PEEK) aromatic polyesters (Ekonol), mineral materials, wollastonite, barium sulfate, and any combination thereof. In one embodiment, the sliding layer 104 consists essentially of a fluoropolymer and a filler.

In addition to the aforementioned metal parts, the work piece of the embodiments can include a car part, a machine part, a building element, or a construction piece. In one particular embodiment, the car part is a door hinge.

Addressing the physical properties of the ally mesh, the aluminum alloy mesh 102 can have a tensile strength of at least about 70 MPa, such as at least about 100 MPa, at least about 150 MPa, at least about 200 MPa, at least about 250 MPa, or at least about 300 MPa. In another embodiment, the aluminum alloy mesh 102 has a tensile strength of not greater than about 350 MPa, such as not greater than about 300 MPa, not greater than about 250 MPa, or not greater than about 200 MPa. In a particular embodiment, the aluminum alloy mesh 102 has a tensile strength between about 300 MPa and about 350 MPa.

In another embodiment, the aluminum alloy mesh 102 has an electrical resistivity of at least about 0.02 (Ωmm2)/m, such as at least about 0.03 (Ωmm2)/m, at least about 0.04 (Ωmm2)/m, at least about 0.05 (Ωmm2)/m, or at least about 0.06 (Ωmm2)/m. In another embodiment, the aluminum alloy mesh 102 has an electrical resistivity of not greater than about 0.07 (Ωmm2)/m, such as not greater than about 0.06 (Ωmm2)/m, not greater than about 0.05 (Ωmm2)/m, or not greater than about 0.04 (Ωmm2)/m. In one particular embodiment, the aluminum alloy mesh 102 has an electrical resistivity between about 0.055 (Ωmm2)/m and about 0.065 (Ωmm2)/m.

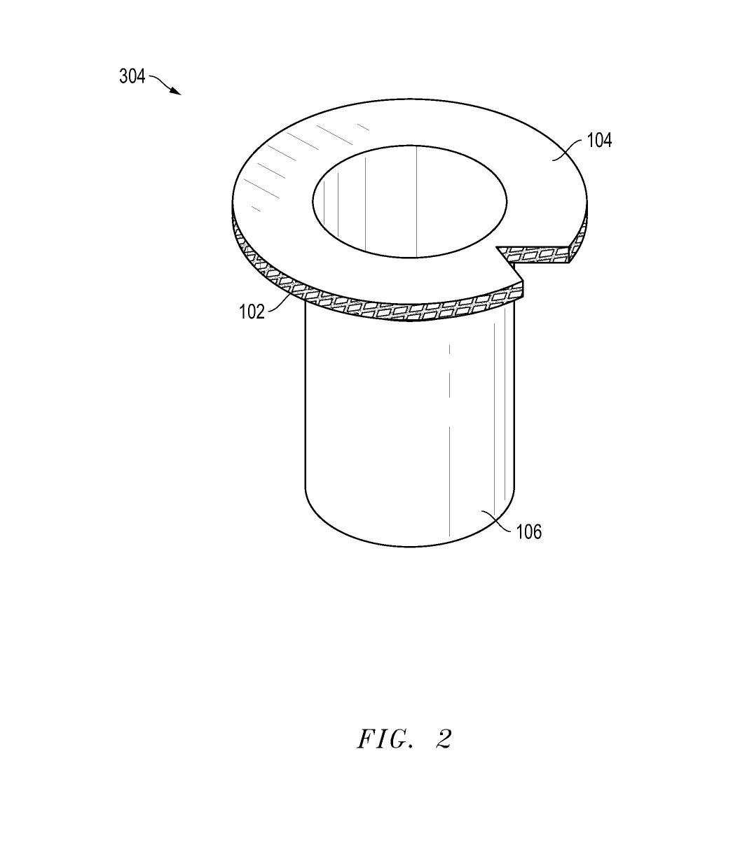

FIG. 2 depicts a work piece made of the laminate 100 in the shape of a bushing 304, The sliding layer 104 defines the internal surface of the bushing which serves the plain bearing function in contact with a rivet of a door hinge, while optional outer layer 106, or in the absence of layer 106, then alloy mesh 102, forms the exterior surface which will be in contact with a hinge part.

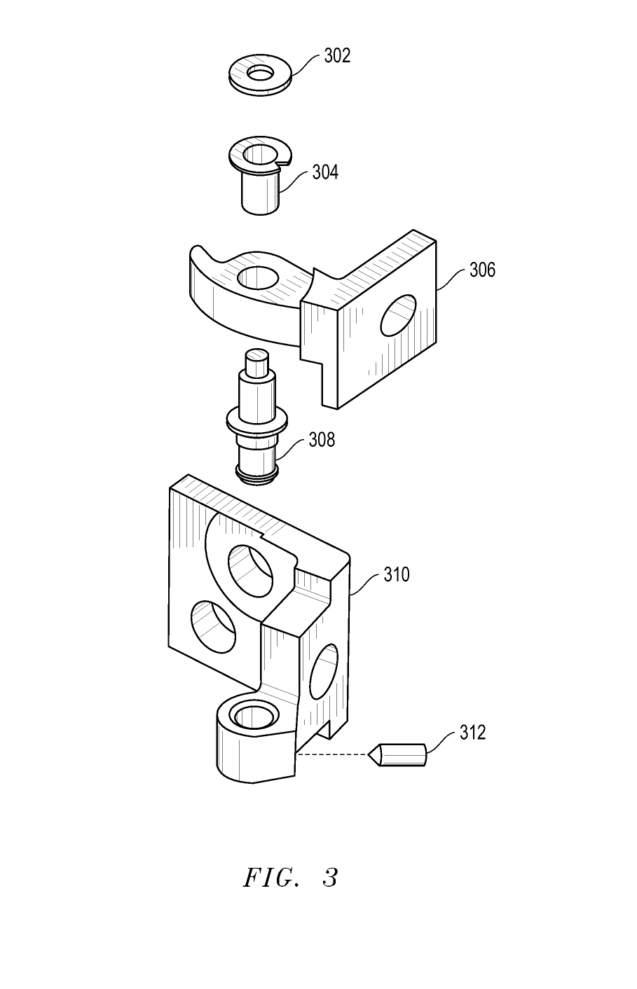

FIG. 3 depicts the parts of a disassembled automobile door hinge including bushing 304, which comprises the plain bearing material including the laminate of an aluminum alloy mesh 102 and a sliding layer 104, as depicted in FIG. 2. Bushing 304 is inserted in hinge door part 306. Rivet 308 bridges the hinge door part 306 with hinge body part 310. Rivet 308 is tightened with hinge body part 310 through set screw 312 and hold in place with the hinge door part 306 through washer 302.

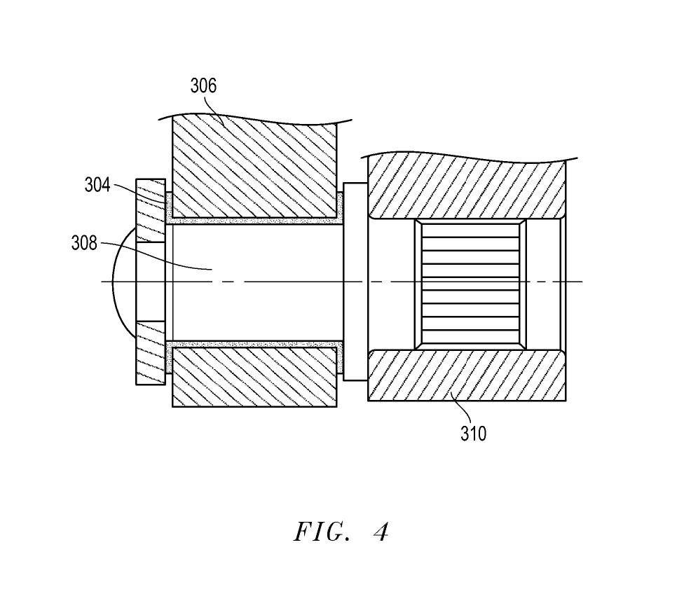

FIG. 4 depicts a cross-sectional view of the assembled door hinge. In the past, points of highest corrosion occur where at the interface of the rivet 308 and the hinge door part 306, since there is the greatest friction between the parts.

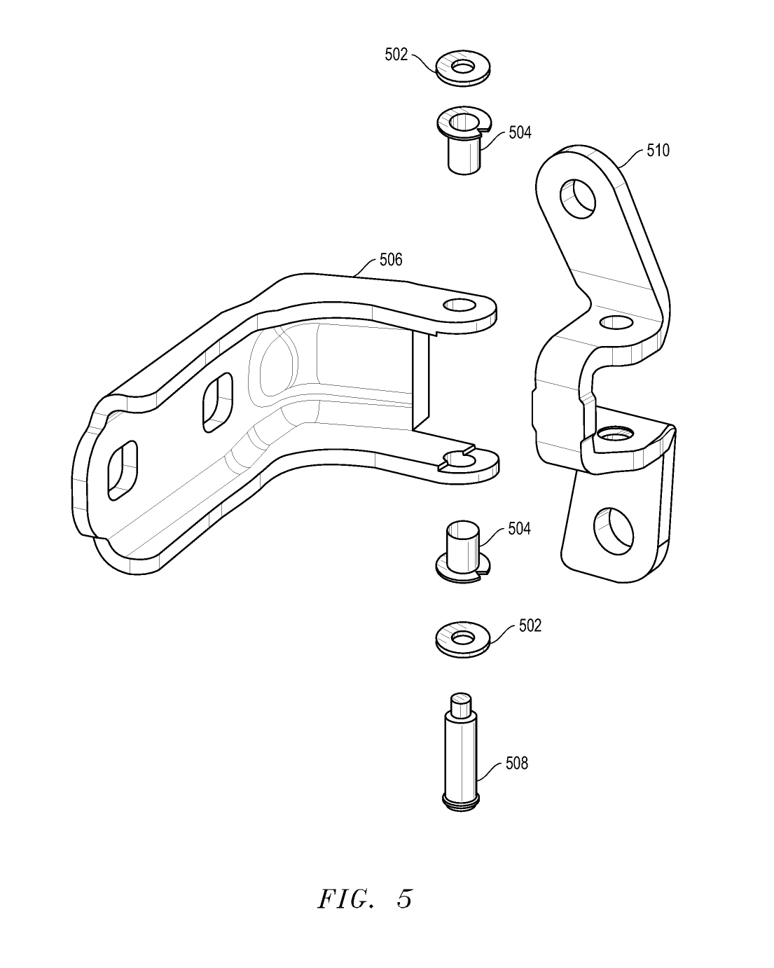

FIG. 5 depicts the parts of a disassembled automobile door hinge according to another embodiment. This door hinge assembly includes two bushings 504 which comprise plain bearing material having an aluminum alloy mesh 102 and a sliding layer 104, as depicted in FIG. 2. Bushings 504 are inserted in hinge door part 506. Rivet 508 bridges the hinge door part 506 with hinge body part 510. Rivet 508 is tightened with hinge body part 510 and hold in place with the hinge door part 506 through washers 502.

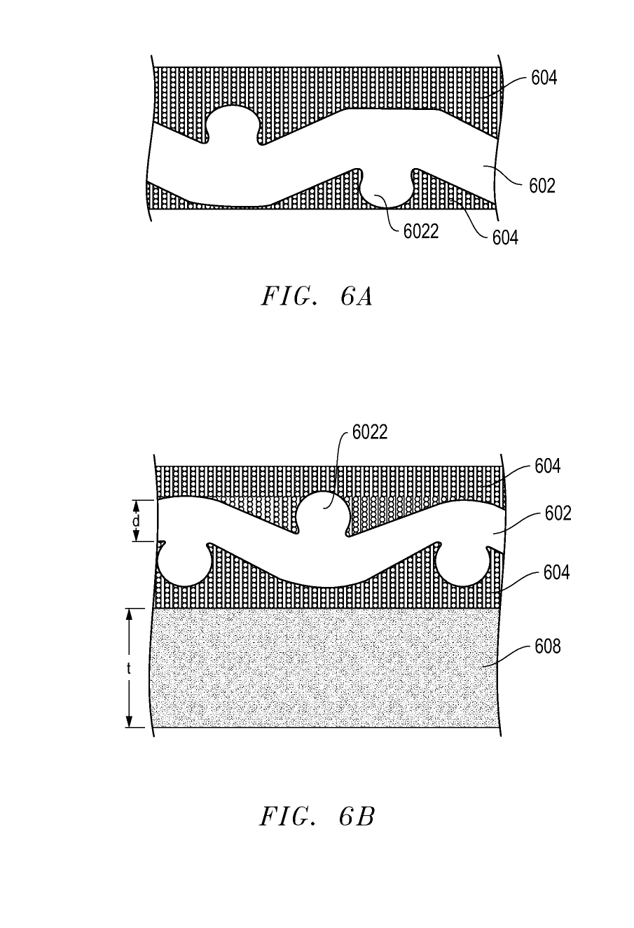

FIG. 6A depicts a line diagram of an SEM picture of an aluminum alloy mesh 602 calandered or embedded into sliding material 604. FIG. 6B depicts an aluminum alloy mesh 602 with wires 6022 running orthogonal to the plane calandered or embedded in sliding material 604 and laminated on a metal support 608. The mesh thickness ‘d’ can be at least about 0.1 mm, such as at least about 0.2 mm, at least about 0.3 mm, at least about 0.4 mm, at least about 0.5 mm, or at least about 0.6 mm. In another embodiment the mesh thickness ‘d’ is not greater than about 0.8 mm, such as not greater than about 0.6 mm, not greater than about 0.5 mm, or not greater than about 0.4 mm. In this particular example, d is about 0.15 mm±0.02 mm. The metal support can have a thickness ‘t’ of at least about 0.1 mm, such as at least about 0.2 mm, at least about 0.3 mm, at least about 0.4 mm, at least about 0.5 mm, or at least about 0.6 mm. In another embodiment the metal support thickness ‘t’ is not greater than about 1.0 mm, such as not greater than about 0.8 mm, not greater than about 0.6 mm, not greater than about 0.5 mm, or not greater than about 0.4 mm.

Another type of an aluminum or aluminum alloy mesh material is an expanded or stretched aluminum or aluminum alloy. Contrary to the mesh depicted in FIGS. 6A and 6B, the expanded metal are not woven but prepared from a aluminum or aluminum alloy sheet having planar major surfaces. The expanded sheets have the advantage that the planarity of at least one major surface is maintained after stretching the metal and creating a metal grate. Such planarity results in an embedded expanded metal sheet with one major surface of the expanded sheet remaining parallel to one major surface of the sliding layer or parallel to the surface of a metal support layer. In one embodiment, the distance between the major surface of the stretched aluminum metal or stretched aluminum alloy metal and the closest surface of the sliding layer can be at least 0.001 mm, such as at least 0.005 mm, at least 0.01 mm, at least 0.05 mm, at least 0.1 mm, or at least 0.2 mm. In another embodiment, the distance cannot be greater than 1 mm, such as not greater than 0.9 mm, not greater than 0.8 mm, not greater than 0.7 mm, not greater than 0.6 mm, not greater than 0.5 mm, or not greater than 0.3 mm. In one embodiment, the thickness ranges from 0.001 mm to 0.5 mm, such as from 0.005 mm to 0.3 mm, or 0.01 mm to 0.2 mm. The stretched metal can have a thickness of at least about 0.1 mm, such as at least about 0.2 mm, at least about 0.3 mm, at least about 0.4 mm, at least about 0.5 mm, or at least about 0.6 mm. In another embodiment the stretched metal thickness is not greater than about 1.0, such as not greater than about 0.9 mm, not greater than about 0.8 mm, not greater than about 0.6 mm, not greater than about 0.5 mm, or not greater than about 0.4 mm.

Another aspect for plain bearings as disclosed in FIG. 6A, i.e. absent of a metal support layer and plain bearings analogous to FIG. 6A with an expanded metal layer instead of a woven mesh is the light weight of these bearings compared to their bronze analogs. In embodiments, the density of a plain bearing according to FIG. 6A and their expanded metal analogs can be less than 3.5 g/cm³, such less than 3.4 g/cm³, less than 3.3 g/cm³, less than 3.2 g/cm³, less than 3.1 g/cm³, less than 3.0 g/cm³, less than 2.9 g/cm³, less than 2.8 g/cm³, less than 2.7 g/cm³, less than 2.6 g/cm³, less than 2.5 g/cm³, less than 2.45 g/cm³, less than 2.4 g/cm³, less than 2.35 g/cm³, less than 2.34 g/cm³, less than 2.33 g/cm³, less than 2.32 g/cm³, less than 2.31 g/cm³, or less than 2.3 g/cm³, less than 2.29 g/cm³, less than 2.28 g/cm³, less than 2.27 g/cm³, less than 2.26 g/cm³, less than 2.255 g/cm³, less than 2.25 g/cm³, or less than 2.245 g/cm³, or less than 2.24 g/cm³. In another embodiment, the density is greater than the density of the sliding material. For example, the density is greater than 2.20 g/cm³.

In one embodiment, the density of plain bearings as disclosed in FIG. 6A, i.e. absent of a metal support layer and plain bearings analogous to FIG. 6A with an expanded metal layer have a density that is an incremental increase of the inherent density D, of the sliding material 604 Dᵢ(SM). In one embodiment, the density of the plain bearing is not greater than 2 times Dᵢ(SM), such as not greater than 1.8 times Dᵢ(SM), not greater than 1.6 times Dᵢ(SM), not greater than 1.4 times Dᵢ(SM), not greater than 1.2 times Dᵢ(SM), not greater than 1.18 times Dᵢ(SM), not greater than 1.16 times Dᵢ(SM), not greater than 1.15 times Dᵢ(SM), not greater than 1.14 times Dᵢ(SM), not greater than 1.13 times Dᵢ(SM), not greater than 1.12 times Dᵢ(SM), not greater than 1.11 times Dᵢ(SM), not greater than 1.1 times Dᵢ(SM), not greater than 1.09 times Dᵢ(SM), not greater than 1.08 times Dᵢ(SM), not greater than 1.07 times Dᵢ(SM), not greater than 1.06 times Dᵢ(SM), not greater than 1.05 times Dᵢ(SM), not greater than 1.04 times Dᵢ(SM), not greater than 1.03 times Dᵢ(SM), not greater than 1.025 times Dᵢ(SM), or not greater than 1.02 times Dᵢ(SM). In another embodiment the density is at least 1.0001 times Dᵢ(SM). In one embodiment, the density can range from 1.0001 times Dᵢ(SM) to 1.2 times Dᵢ(SM), such as from 1.001 times Dᵢ(SM) to 1.1 times Dᵢ(SM), from 1.005 times Dᵢ(SM) to 1.08 times Dᵢ(SM), or from 1.005 times Dᵢ(SM) to 1.04 times Dᵢ(SM).

In yet another aspect, embodiments according to the two foregoing paragraphs can further be laminated on a metal support to form a laminate according to FIG. 6B and its analog where the mesh is replaced by a stretched metal. For light weight application the metal support can include aluminum support, or an aluminum alloy support. In one particular embodiment, a laminate can include an embedded AlMg₅ aluminum alloy stretched metal in the sliding material to form the sliding layer. In one embodiment, this sliding layer can overlie a steel support. In another embodiment, this AlMg5 type sliding layer can overlie an aluminum or aluminum alloy support. In one particular embodiment this AlMg5 type sliding layer can be placed on an AlMg5 sheet or stretched metal. Moreover, embodiments are contemplated within the scope of this application including more than one mesh or stretched metal reinforcement layer. The fact that the density of the sliding layer increases only by 1 to 10% compared to the inherent density of the sliding material Dᵢ(SM) when aluminum or aluminum alloy meshes or stretched layers are used allows for application of light weight bearings where such bearings are needed such as in the sporting industry, e.g., bicycle industry, or in the space and aeronautic industry. Further in view of the increased corrosion resistance and light weight of the plain bearings, bearings in the boating industries are within in the scope of this invention.

### EXAMPLES

For automobile door hinges, two tests were conducted, a salt spray test to evaluate the corrosion properties of an assembled door hinge and a door durability test to evaluate the performance of bushings and plain bearings comprising the aluminum alloy mesh.

### Example 1

Salt Spray Test

Hinges with a bushing 304 comprising an AlMg5 aluminum mesh (H_{AL}) and hinges with a bronze mesh (H_{BR}) were subjected to a salt spray test according to DIN ISO 9227:2006 NSS or ASTM B117. Samples were passivated with Zn and included a steel backing layer. The employed spray method was a neutral Salt Spray (Fog) of an aqueous NaCl solution at a concentration of 50 g/L. The Chamber temperature was maintained at 35° C., the pH value was between 6.5 and 7.3. The hinges were visually investigated for corrosion after 24 hours of salt spray testing and after 408 hours of salt spray testing. After 240 hours the H_{BR} showed red corrosion over the entire hinge. Table 1 summarizes the test results.

TABLE 1
Salt Spray Test results on hinges comprising
aluminum alloy mesh or bronze mesh

| | After 24 hours | After 408 hours |
|---|---|---|
| H_{BR} | Substantial zinc corro- | Red dust formation (rust) covering |
| | sion around rivets and | entire rivet and door hinge part with |
| | door hinge part | significant corrosion of door hinge |
| | | part near bushing area |
| H_{AL} | Insignificant amount of | No rust formation next to bushing area |
| | zinc corrosion around | on hinge part and rivet; minimal rust |
| | entire part | formation in door anchoring portion of |
| | | the door hinge part |

The Salt Spray Test clearly identifies the improvement of a bushing comprising an aluminum mesh over the bronze bushings with respect to galvanic corrosion. In another test according to ASTM B117, shown in Table 2, samples of aluminum samples underwent salt spray testing until they show some red rust and/or delamination.

TABLE 2
Salt Spray Test results on hinges comprising
mesh or expanded aluminum alloy

| | Type of | |
|---|---|---|
| | reinforcement | Time and Observation of |
| Sample description | layer | corrosion |
| 1 mm Al on Steel | Mesh | 454 hours until slight red |
| | | dust was formed; no delam- |
| | | ination |
| 0.75 mm Al on Steel | Mesh | 454 hours until red dust |
| (plated with Zn) | | was formed; no delamination |
| 0.75 mm Al on Al | Stretched metal | 1178 hours, no delamination |

Door Durability Test

Car doors comprising hinges having bushings 304 including an AlMg5 aluminum alloy mesh (H_{AL}) and hinges with a bronze mesh (H_{BR}) were subjected to 100,000 cycles of load stress. The door drop test is a specific OEM procedure. In this test a car door of a specific weight is connected with two hinges to an column. The end of the door is stressed with a gravitational load of a specified amount. After removing the load, plastic deformation is measured. The door must not drop more than 0.3 mm to pass the test.

The drop of the door part hinge and the car body part of the hinge were determined after 100,000 cycles. Table 3 summarizes the results.

TABLE 3
Door Drop Test

| | Drop (door | Drop (car body | Ratio (column 2/ |
|---|---|---|---|
| | hinge)/mm | hinge)/mm | column 1) |
| H_{BR} | 0.076 | 0.025 | 3.04 |
| H_{AL} | 0.229 | 0.076 | 3.01 |

Since the relative drop of the door hinges are comparable, the hinges comprising aluminum alloy mesh bushings fulfill the same industrial demand as their bronze containing analogs.

Density Measurement

The density for sliding layers of a bushing 304 comprising an AlMg5 aluminum mesh (H_{AL}) and hinges with a bronze mesh (H_{BR}) were determined. The hinges did not include another metal support. H_{Al} had a density of 2.242 g/cm³ and H_{BR} measured a density of 4.235 g/cm³.

PTFE has a density of about 2.20 g/cm³. As can be seen from the foregoing data, the increase of the density for H_{AL} is minimal, i.e. less than 10% while a bronze mesh almost doubles the density of a PTFE sliding layer (4.235/2.20=1.925)

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A method of reducing corrosion of a corrosive metal containing work piece, the method comprising:
providing a corrosive metal containing work piece, the corrosive metal containing work piece having a non-planar surface;
covering at least about 10% of the non-planar surface with a laminate, the laminate comprising
an aluminum alloy mesh having a first major surface and a second major surface, and
a sliding layer overlying the first major surface and in direct contact with the aluminum alloy mesh, wherein the second major surface of the aluminum alloy mesh is in direct contact with at least 50% of the non-planar surface.

2. (canceled)

3. The method according to claim 1, wherein the aluminum alloy mesh comprises aluminum magnesium alloy.

4. The method according to claim 1, wherein the aluminum alloy mesh has a mesh size of at least 10 mesh/inch, such as at least 11 mesh/inch, at least 13 mesh/inch, at least 15 mesh/inch, at least 17 mesh inch, at least 19 mesh/inch, or at least 21 mesh/inch.

5. (canceled)

6. The method according to claim 1, wherein the sliding layer comprises a fluoropolymer.

7-19. (canceled)

20. A corrosion protection article comprising a bushing, the bushing being in a non-planar shape and shaped to enfold a work piece having a non-planar surface, the bushing comprising
an aluminum alloy mesh having a first major surface and a second major surface, and
a sliding layer overlying the first major surface and in direct contact with the aluminum alloy mesh.

21. The corrosion protection article according to claim 20, the bushing being shaped complementary to the work piece, wherein when the bushing is engaged with the work piece, the second major surface of the aluminum alloy mesh is in direct contact with the non-planar surface of the work piece.

22. The corrosion protection article of claim 20, wherein the work piece is a corrosive metal containing work piece.

23. The corrosion protection article of claim 20, wherein the aluminum alloy mesh comprises aluminum magnesium alloy.

24. The corrosion protection article of claim 20, wherein the aluminum alloy mesh has a mesh size of at least 10 mesh/inch, such as at least 11 mesh/inch, at least 13 mesh/inch, at least 15 mesh/inch, at least 17 mesh inch, at least 19 mesh/inch, or at least 21 mesh/inch.

25. The corrosion protection article of claim 20, wherein the aluminum alloy mesh has a thickness of at least about 0.1 mm, such as at least about 0.2 mm, at least about 0.3 mm, at least about 0.4 mm, at least about 0.5 mm, or at least about 0.6 mm.

26. The corrosion protection article of claim 20, wherein the sliding layer comprises a fluoropolymer.

27. The corrosion protection article of claim 26, wherein the fluoropolymer is selected from the group consisting of polychlorotrifluoroethylene (PCTFE), polytetrafluoroethylene (PTFE), tetrafluoroethylene-perfluoro(alkyl vinyl ether) copolymer (PFA), tetrafluoroethylene-hexafluoropropylene copolymer (FEP), tetrafluoroethylene-ethylene copolymer (ETFE), polyvinylidene fluoride (PVDF) and polyvinyl fluoride (PVF), and a laminated film comprising two or more thereof.

28-33. (canceled)

34. The corrosion protection article of claim 20, wherein the aluminum alloy mesh has a tensile strength of at least about 70 MPa, such as at least about 100 MPa, at least about 150 MPa, at least about 200 MPa, at least about 250 MPa, or at least about 300 MPa.

35-36. (canceled)

37. The corrosion protection article of claim 20, wherein the aluminum alloy mesh has an electrical resistivity of at least about 0.02 (Ωmm²)/m, such as at least about 0.03 (Ωmm²)/m, at least about 0.04 (Ωmm²)/m, at least about 0.05 (Ωmm²)/m, or at least about 0.06 (Ωmm²)/m.

38-39. (canceled)

40. An article comprising a first body, wherein a portion of the first body moveably engages a second body, the first body having a contoured external surface and a contoured internal surface, wherein the first body comprises an aluminum alloy mesh and a sliding layer overlying the aluminum alloy mesh, the sliding layer comprising the external surface and the aluminum alloy mesh comprising the internal surface.

41-42. (canceled)

43. The article of claim 40, wherein the aluminum alloy mesh comprises aluminum magnesium alloy.

44-49. (canceled)

50. The article of claim 40, wherein the sliding layer further comprises a filler.

51. The article of claim 50, wherein the filler is selected from fibers, glass fibers, carbon fibers, aramids, inorganic materials, ceramic materials, carbon, glass, graphite, aluminum oxide, molybdenum sulfide, bronze, silicon carbide, woven fabrics, powders, spheres, thermoplastic materials, polyimide (PI), polyamidimide (PAI), polyphenylene sulfide (PPS), polyphenylene sulfone (PPSO2), liquid crystal polymers (LCP), polyether ether ketones (PEEK) aromatic polyesters (Ekonol), mineral materials, wollastonite, barium sulfate, or any combination thereof.

52-55. (canceled)

56. The article of claim 40, wherein the aluminum alloy mesh has a tensile strength between 300 MPa and 350 MPa.

57-58. (canceled)

59. The article of claim 40, wherein the aluminum alloy mesh has an electrical resistivity between about 0.055 (Ωmm²)/m and about 0.065 (Ωmm²)/m.

60-99. (canceled)
